(19) United States
(12) Patent Application Publication
(10) Pub. No.: US 2026/0316163 A1
(43) Pub. Date: Oct. 15, 2026

(54) METHOD FOR DRILLING A COMMUNICATION CHANNEL BETWEEN TWO HOLES, IN PARTICULAR PARALLEL HOLES, AND MASTER CYLINDER OR TMC WITH SUCH A COMMUNICATION CHANNEL

(71) Applicant: Robert Bosch GmbH, Stuttgart (DE)

(72) Inventors: Artur Sciesinski, Domaszczyn (PL); Florent Yvonet, Trilport (FR); Hugo Vazquez, Poissy (FR); Nicolas Quiniou, Villemomble (FR)

(21) Appl. No.: 19/639,474

(22) Filed: Apr. 6, 2026

(30) Foreign Application Priority Data
Apr. 15, 2025 (FR) 25 04043

(51) Int. Cl. B23B 41/12; B23B 35/00; B60T 11/16; B60T 11/20; F15B 15/14

(52) U.S. Cl. CPC B23B 41/12; B23B 35/00; B60T 11/165; B60T 11/20; F15B 15/1404

(57) ABSTRACT

A method for drilling, using a drilling tool, a transverse communication channel between two first and second holes having respective longitudinal axes inclined relative to one another at an angle strictly less than 90°, in particular parallel to one another, in a main body, in particular a master cylinder body, in particular TMC, at least the first hole opening outside the main body. In the method, the tool is inserted through the outer opening of the first hole; and the tool is used to strike the wall forming the first hole until it reaches the second hole, thus creating a transverse communication channel.

### CROSS REFERENCE

The present application claims the benefit under 35 U.S.C. § 119 of France Patent Application No. FR 25 04043 filed on Apr. 15, 2025, which is expressly incorporated herein by reference in its entirety.

### FIELD

The present disclosure relates to a method for drilling a communication channel between two holes inclined relative to one another by an angle of strictly less than 90°, in particular parallel, in particular in a master cylinder, in particular a tandem master cylinder (TMC), as well as to a master cylinder or a TMC comprising such a communication channel.

### BACKGROUND INFORMATION

Braking systems typically use a master cylinder, in particular a tandem master cylinder, consisting of a base body of substantially cylindrical shape defining within it an interior space in which at least one piston moves under the thrust of an actuator, the movement of the actuator being controlled by a brake pedal, either via a booster arranged between the actuator and the brake pedal and controlled electronically by an electrical unit, or, if the booster fails, directly via the mechanical connection to the pedal, or via an electrical wire connection between the pedal and the electrical unit controlling an electric motor acting on the actuator, the interior space of the master cylinder being in fluid communication, on the one hand, via at least one vertical-axis inlet manifold, with a brake fluid reservoir, and on the other hand, via at least one outlet manifold, with at least one hydraulic brake circuit acting on the brakes.

It would be desirable to be able to establish communication between two parallel holes formed in the body of the master cylinder, in particular TMC, for example an inlet manifold with a vertical axis and a parallel channel formed in the body of the master cylinder, by means of a transverse communication channel between the two holes.

However, conventional techniques for producing this transverse channel require the master cylinder body to be drilled at the vertical inlet manifold, with the drilling tool striking the material of the base body from the outside until it opens into the inlet manifold, and then again striking the material of the manifold wall on the opposite side from where the tool opened out, until it opens into the parallel channel to form the transverse channel.

This technique is complex and costly, and in particular requires a sealing ball to be forced into the part of the conduit between the outside and the inlet manifold. In addition, the sealing achieved by the ball is susceptible to degradation, reducing the service life of the TMC.

### SUMMARY

An object of the present disclosure is to overcome the disadvantages of the related art by providing a simpler and less costly method for drilling a transverse communication channel between two longitudinal holes inclined relative to one another at an angle strictly less than 90°, in particular parallel to one another, and which also makes it possible to achieve a better seal.

According to an example embodiment of the present disclosure, the method for drilling, using a drilling tool, for example of the drill type, a transverse communication channel between two first and second holes having respective longitudinal axes inclined relative to one another at an angle strictly less than 90°, in particular parallel to one another, in a main body, in particular a master cylinder body, in particular TMC, at least the first hole opening outside the main body, includes the steps in which:
the tool is inserted through the outer opening of the first hole;
the tool is used to strike the side wall of the first hole, in particular from the region of the wall closest to the second hole, until it reaches the second hole, thus creating a transverse communication channel.

Preferably, the transverse communication channel has a longitudinal axis that forms an angle relative to the longitudinal axis of the first hole which is strictly less than 90°.

The fact that it is provided to drill a hole by having the drilling tool strike directly against the wall on the side of the other hole, without having to make a pre-drilling from the outside of the base body, as in the related art, results in a faster method, since in particular the first drilling is dispensed with, and in addition, when the first hole is to be sealed, a complicated step of inserting a sealing ball into the part of the pre-drilling is dispensed with. Furthermore, the seal obtained is no longer limited by the tightness of the interface between the pre-drilling and the ball, and therefore has a longer service life.

Preferably, the two longitudinal holes are parallel to one another.

Preferably, the two holes have respective vertical axes.

According to a first preferred example embodiment, the drilling tool is of the cylindrical drill type, with a cross-section substantially equal to the cross-section of the communication channel.

Preferably, the first hole has, between its outward opening and the drilling region, a cross-section of smaller diameter, referred to as the first diameter, the cross-section of the second hole is constant and has a second diameter, and the cross-section of the communication channel is constant and has a third diameter, and the first diameter is larger than the second diameter and the third diameter.

Preferably, the second diameter is larger than the third diameter.

According to another preferred example embodiment, the drilling tool is a T-slot milling cutter, comprising a cylindrical handle terminating in a disk-shaped head, the peripheral edge of which defines milling teeth, the diameter of the disk being smaller than that of the cross-section of the first hole.

Preferably, in cross-section in the plane comprising the longitudinal axis of the communication channel and the perpendicular to the longitudinal axis of the first hole and to the longitudinal axis of the second hole, the first hole and the communication channel define a figure-of-eight shape, the circle of which corresponding to the channel is smaller than the circle corresponding to the first hole.

Preferably, the communication channel has a cross-section, relative to its longitudinal axis, which decreases along the longitudinal axis from the end of the first hole to the second hole.

In particular, the cross-section of the communication channel is rectangular, with one of its sides, in particular its length, decreasing along the longitudinal axis from the end of the first hole to the second hole.

The present disclosure also relates to a master cylinder, in particular a TMC, comprising at least one communication channel produced by the method according to the present disclosure.

In particular, the master cylinder, in particular TMC, consists of a substantially cylindrical base body defining within it an interior space in which at least one piston can move, the interior space of the master cylinder being able to be brought into fluid communication on the one hand, via at least one inlet manifold having a vertical axis, with a brake fluid reservoir, and on the other hand, via at least one outlet manifold, with at least one hydraulic brake circuit acting on the brakes, characterized in that at least one bypass channel is provided, having a longitudinal axis which is inclined relative to the vertical axis of the at least one inlet manifold by an angle strictly less than 90°, in particular also vertical, in fluid communication on the one hand with the interior space of the master cylinder and on the other hand with the relevant inlet manifold, and a communication channel, having a longitudinal axis and providing fluid communication between the at least one inlet manifold and the at least one bypass channel, and either the longitudinal axis of the communication channel forms an angle strictly less than 90° with the vertical axis of the at least one inlet manifold, or the communication channel has a rectangular cross-section, relative to its longitudinal axis, the length of which decreases from the section corresponding to the point on the virtual circle of the at least one inlet manifold closest to the at least one bypass channel, as far as the at least one bypass channel.

Preferably, at least one suction valve is received in the at least one inlet manifold, and the communication channel extends from the at least one inlet manifold, upstream of the valve, to the at least one bypass channel.

By providing a suction valve in this way, an ESP can, by controlling a pump, supplement, or even replace in the most critical cases, the action of pressurizing the liquid by the piston, in particular in the event of the piston failing and blocking the bypass channel, in order to thus act on the brakes. In particular, this ensures that, as the brake fluid viscosity increases, the system can still maintain optimum fluid flow and pressure. Similarly, in the event of an electrical fault, the emergency mode can be activated, allowing a significant supply of brake fluid, in particular via both the inlet manifold and the bypass channel simultaneously, to ensure effective braking, in particular under extreme conditions having a negative influence on flow, for example by increasing fluid viscosity.

This improves the fluid intake capacity of the braking system.

In particular, the result is a braking system with improved braking performance and greater ease of use, which is also particularly well suited to wire braking.

Thus, according to one example embodiment, the movement of the mechanical actuator is controlled by an electrical unit that receives a signal from the brake pedal via an electrical wire, with which signal the electrical unit determines the braking force and consequently controls the corresponding action of the actuator via an electric motor.

In another example embodiment, the brake pedal sends a signal to the ESP via an electric wire, with which signal the ESP determines the braking force and consequently controls the corresponding pump action via an electric motor.

The two example embodiments described above can be used in combination, or on their own.

Preferably, respective suction valves are received in the respective primary and secondary inlet manifolds.

### BRIEF DESCRIPTION OF THE DRAWINGS

By way of example, the figures show preferred example embodiments of the present disclosure.

FIG. 1 is a schematic view of a vehicle comprising a mechanical braking system comprising a booster.

FIG. 2 is a schematic view of a vehicle comprising a wire braking system.

FIG. 3 is a longitudinal cross-sectional view of part of a tandem master cylinder or TMC according to an example embodiment of the present disclosure.

FIG. 4 is a cross-sectional view, along a plane B including the longitudinal axis of the communication channel and the axis perpendicular to the longitudinal axis of the master cylinder and to the vertical axis of the inlet manifold, of the example embodiment shown in FIG. 3.

### DETAILED DESCRIPTION OF EXAMPLE EMBODIMENTS

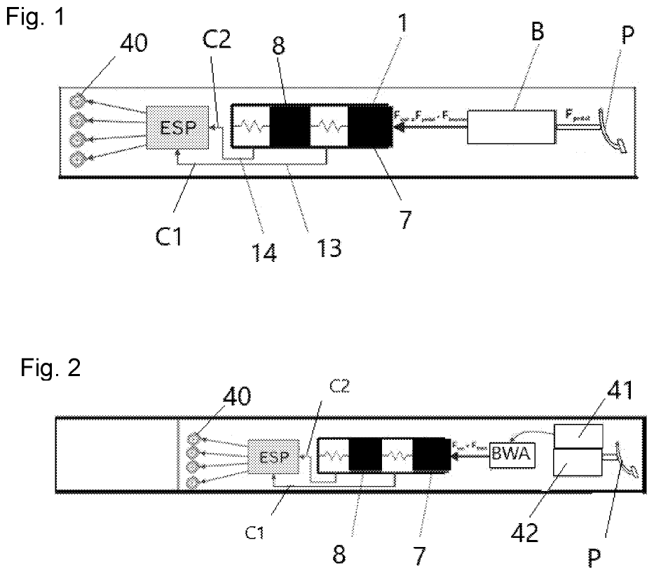

FIG. 1 schematically shows a motor vehicle in which the driver acts (F_{pedal}) on a pedal P to control, via an electrical unit, a booster B (Fout=F_{pedal}+F_{booster}) acting on a primary piston moving in an interior space of a TMC 1 comprising two outlet manifolds 13 and 14, primary and secondary respectively, in communication with the hydraulic braking circuits C1 and C2, under the control of an ESP, which act on the brake calipers 40.

Should the actuator and/or booster fail, the driver still has the option of pushing the piston directly (known as the “push thru” function).

The ESP receives a braking signal from the pedal, via a sensor and the electrical unit, and on the basis of this signal the ESP can control a pump to open two suction valves, primary and secondary respectively, arranged in the TMC 1, between the fluid reservoir 10 and two inlet manifolds, primary and secondary respectively, to thus, in the event of an emergency or actuator failure, hydraulically control braking or supplement it.

FIG. 2 schematically shows a motor vehicle in which the driver acts on a pedal P to control, via an electrical unit, a booster acting (Fout=F_{BWA}) on a primary piston moving in an interior space of a TMC 1 comprising two outlet manifolds 13 and 14, primary and secondary respectively, in communication with the hydraulic braking circuits, under the control of an ESP.

The BWA actuator is not mechanically linked to the pedal, and its movement is controlled by an electric motor controlled by the electrical unit 41 on the basis of a signal received from a sensor 42 which determines, from the pedal travel and the force applied by the driver, the desired braking.

If the actuator fails, the driver cannot push the piston directly (the “push-thru” function is not available).

The ESP receives a braking signal from the pedal, via a sensor and the electrical unit, and on the basis of this signal the ESP can control a pump to open two suction valves, 15 primary and 16 secondary respectively, located in the TMC 1, between the fluid reservoir 10 and two respective primary 11 and secondary 12 inlet manifolds having a vertical axis, to thus, in the event of an emergency or actuator failure, hydraulically control braking or supplement it.

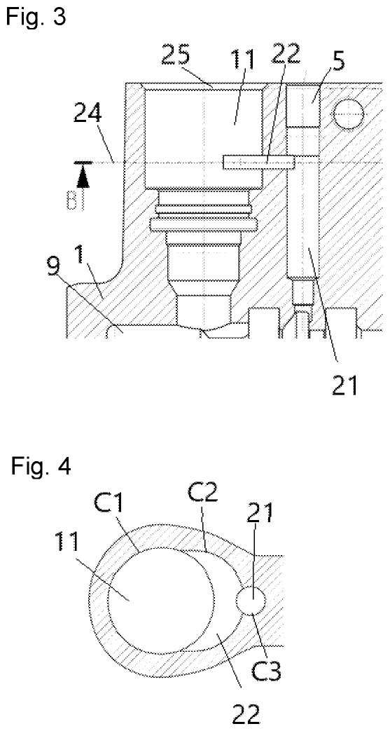

FIG. 3 shows part of the TMC 1. This TMC 1, in a conventional manner, comprises a primary piston 7 and a secondary piston 8 which move back and forth in the interior space 9 of the cylinder under the thrust of an actuator (not visible in the drawing) and against return springs, primary and secondary respectively, to create a hydraulic pressure transmitted to respective brake circuits, via the two primary 13 and secondary 14 outlet manifolds.

The two inlet manifolds, primary 11 and secondary respectively, having a vertical axis, provide fluid communication between the brake fluid reservoir and the interior space 9, respectively.

In addition, a primary bypass channel 5 and a secondary bypass channel (not visible in the drawing) are provided, which provide fluid communication between the inlet manifolds, upstream of the valves, and the interior space 9. These channels also open to the outside of the cylinder body, in particular as shown at the top, and are plugged by balls 20 force-fitted from above.

Each of these two bypass channels opens out into the interior space 9 and each allows brake fluid to pass from the reservoir into the interior space when the two pistons are in the rest position, not pushed by the actuator, and no braking is required. Thus, in normal system operation, they provide the fluid supply for brake action, when the two pistons, under the action of the actuator, increase the pressure in the interior space, the valves then being normally closed.

In addition, a relevant suction valve 15 is arranged in each inlet manifold, allowing, when the ESP operates a pump (not visible in the drawings), additional communications between the reservoir and the interior space 9 to be opened, which are not prevented by the position of the pistons being undesirably blocked in the depressed position.

In addition, in the case of normal piston operation, these valves make it possible, under the control of the ESP via the pump, by suction, to increase the quantity of brake fluid which is sent into the interior space, thus improving brake fluid flow and therefore braking effectiveness, in particular under extreme conditions which have a negative influence on flow, for example by increasing fluid viscosity.

The primary bypass channel 5 consists of a primary vertical through-hole 21 opening outside the cylinder body and into the interior space 9. It is in fluid communication with the primary inlet manifold 11 via a communication channel 22, and is closed at the top by a ball 20 press-fitted from the outside of the master cylinder.

In the embodiment shown in FIG. 3, the communication channel 22 was created using a T-slot milling cutter, which was introduced directly from the outside into the inlet manifold 11, in order to be able to strike the inner wall 23 of the inlet manifold 11.

The communication channel 22 was created using a drilling tool consisting of a T-slot milling cutter, comprising a cylindrical handle terminating in a disk-shaped head, the peripheral edge of which defines milling teeth, the diameter of the disk being smaller than that of the cross-section of the first hole, in order to allow it to be inserted.

The tool was introduced through the outer opening of the manifold 11, by orienting the cutter disk so that it was parallel to the longitudinal axis of the channel 22, and it was ensured that the cutter teeth strike the wall of the manifold 11 until they reach the vertical hole 21.

FIG. 4 shows the cross-section in relation to the axis perpendicular to the longitudinal axis of the communication channel, in the region of the communication channel. The inlet manifold 11 and communication channel 22 define there a figure-of-eight shape of which the circle C2 corresponding to the channel 22 has a smaller diameter than the diameter of the circle C1 corresponding to the inlet manifold 11.

The communication channel 22 has a rectangular cross-section, relative to its longitudinal axis, the width of which (corresponding to the thickness of the T-slot milling cutter disk) is constant, and the length of which decreases from the section corresponding to the point of the circle C1 of the inlet manifold 11 closest to the through-hole 21 (this point is the point of the circle which passes through the longitudinal axis, and it corresponds, in the present description, to the end of the inlet manifold) to the through-hole 21 of circular cross-section C3.

What is claimed is:

1. A method for drilling in a main body of a master cylinder, using a drilling tool, a transverse communication channel between a first hole and a second hole having respective longitudinal axes inclined relative to one another at an angle strictly less than 90°, wherein the first hole opens outside the main body, the method comprising the following steps:
inserting the tool through an outer opening of the first hole; and
striking, using the tool, a wall forming the first hole, from a region of a wall closest to the second hole, until the tool reaches the second hole to create a transverse communication channel.

2. The method according to claim 1, wherein the respective longitudinal axes of the first hole and the second hole are parallel to one another.

3. The method according to claim 1, wherein the master cylinder is a tandem master cylinder.

4. The method according to claim 1, wherein the communication channel has a longitudinal axis that forms an angle relative to the respective longitudinal axis of the first hole which is strictly less than 90°.

5. The method according to claim 1, wherein the first and second holes are parallel to one another, and have respective vertical axes.

6. The method according to claim 1, wherein the drilling tool is of a cylindrical drill type, with a circular cross-section substantially equal to a cross-section of the communication channel.

7. The method according to claim 1, wherein the drilling tool is a T-slot milling cutter, including a cylindrical handle terminating in a disk-shaped head, a peripheral edge of disk-shaped head defines milling teeth, a diameter of the disk-shaped head being smaller than that of the cross-section of the first hole.

8. The method according to claim 7, wherein in cross-section, in a plane including the longitudinal axis of the communication channel and a perpendicular to the respective longitudinal axis of the first hole and to the respective longitudinal axis of the second hole, the first hole and the communication channel define a figure eight shape, a circle of the figure eight shape that corresponds to the communication channel is smaller than a circle of the figure eight that corresponds to the first hole.

9. The method according to claim 7, wherein the communication channel has a cross-section, relative to a longitudinal axis of the communication channel, which decreases from an end of the first hole to the second hole.

10. A master cylinder, comprising:
a main body including:
a first hole and a second hole having respective longitudinal axes inclined relative to one another at an angle strictly less than 90°, wherein the first hole opens outside of the main body, and
a transverse communication channel connecting the first hole and the second hole together, the communication channel being produced by:
inserting the tool through an outer opening of the first hole, and
striking, using the tool, a wall forming the first hole, from a region of a wall closest to the second hole, until the tool reaches the second hole to create a transverse communication channel.

11. The master cylinder according to claim 10, wherein the master cylinder is a tandem master cylinder (TMC).

12. A master cylinder, comprising:
a cylindrical base body defining within the base body an interior space in which at least one piston can move, the interior space being able to be brought into fluid communication on the one hand, via at least one inlet manifold having a vertical axis, with a brake fluid reservoir, and on the other hand, via at least one outlet manifold, with at least one hydraulic brake circuit acting on brakes;
wherein the base body includes a bypass channel, having a longitudinal axis which is inclined relative to a vertical axis of the at least one inlet manifold by an angle strictly less than 90°, in fluid communication on the one hand with the interior space of the master cylinder and on the other hand with at least one inlet manifold, and the base body includes a communication channel, having a longitudinal axis and providing fluid communication between the at least one inlet manifold and the bypass channel, and wherein: (i) the longitudinal axis of the communication channel forms an angle strictly less than 90° with the vertical axis of the at least one inlet manifold, or (ii) the communication channel has a rectangular cross-section, relative to the longitudinal axis of the communication channel, a length of which decreases from a section corresponding to a point on a virtual circle of the at least one inlet manifold closest to the bypass channel, to the bypass channel.

13. The master cylinder, according to claim 12, wherein at least one suction valve is received in the at least one inlet manifold, and the communication channel extends from the at least one inlet manifold, upstream of the at least one valve, to the bypass channel.

14. A motor vehicle braking system, comprising:
a master cylinder, including:
a cylindrical base body defining within the base body an interior space in which at least one piston can move, the interior space being able to be brought into fluid communication on the one hand, via at least one inlet manifold having a vertical axis, with a brake fluid reservoir, and on the other hand, via at least one outlet manifold, with at least one hydraulic brake circuit acting on brakes of the motor vehicle,
wherein the base body includes a bypass channel, having a longitudinal axis which is inclined relative to a vertical axis of the at least one inlet manifold by an angle strictly less than 90°, in fluid communication on the one hand with the interior space of the master cylinder and on the other hand with at least one inlet manifold, and the base body includes a communication channel, having a longitudinal axis and providing fluid communication between the at least one inlet manifold and the bypass channel, and wherein: (i) the longitudinal axis of the communication channel forms an angle strictly less than 90° with the vertical axis of the at least one inlet manifold, or (ii) the communication channel has a rectangular cross-section, relative to the longitudinal axis of the communication channel, a length of which decreases from a section corresponding to a point on a virtual circle of the at least one inlet manifold closest to the bypass channel, to the bypass channel.
